(19) United States
(12) Patent Application Publication
(10) Pub. No.: US 2014/0114475 A1
(43) Pub. Date: Apr. 24, 2014

(54) APPARATUS AND METHOD FOR SHARING DEVICE RESOURCES BETWEEN ROBOT SOFTWARE COMPONENTS

(71) Applicant: ELECTRONICS AND TELECOMMUNICATIONS RESEARCH INSTITUTE, Daejeon (KR)

(72) Inventors: Byoung Youl SONG, Daejeon (KR); Seung-Woog JUNG, Daejeon (KR); Choulsoo JANG, Daejeon (KR); Sung Hoon KIM, Daejeon (KR)

(21) Appl. No.: 13/919,467

(22) Filed: Jun. 17, 2013

(30) Foreign Application Priority Data
Oct. 18, 2012 (KR) 10-2012-0116146

(51) Int. Cl. B25J 9/16

(52) U.S. Cl. CPC B25J 9/161
USPC 700/245

(57) ABSTRACT

In an apparatus for sharing device resources between robot software user components, a callback module of a robot software user component receives data forwarded from a device set to be shared between the robot software user components, a device service surrogate has a connection with a framework to forward data to the device or forward data received through the callback module to a user program of the user components; a device service surrogate manager manages the device service surrogate of each of the user components; a device channel has a connection with the device to receive data therefrom and transmit data thereto; and a device channel manager manages the device channel and connect the device channel and the device service surrogate.

### RELATED APPLICATIONS

This application claims the benefit of Korean Patent Application No. 10-2012-0116146, filed on 18 Oct. 2012, which is hereby incorporated by reference as if fully set forth herein.

### FIELD OF THE INVENTION

The present invention relates to a robot software component, and more particularly, to an apparatus and method for sharing a plurality of device resources between a plurality of robot software user components, which allows the user components to share the device resources in a robot software platform so that a robot application developer can further effectively configure a robot system.

### BACKGROUND OF THE INVENTION

Usually, when a robot application developer configures a robotic system, there are commonly utilized three methods.

First, a first method is to configure a robot system with one embedded board having OS (operating system) loaded thereon wherein devices such as wheels or sensors are connected directly to the board. In this case, it is necessary for a robot developer to install device drivers and components for the devices coupled to the board, which brings constraint incapable of using this method unless the device drivers adapted for newly-produced devices or the OS do not be provided from a manufacturing company.

The second method is to configure a robot system with two or more embedded boards having OS loaded thereon wherein sub-boards to which actuators and sensors are coupled and a master board on which applications are running are connected to the same network such as an Ethernet. Even in this case, a robot developer needs to acquire all the device drivers, which forms constraint.

The third method takes a form in which a master board, which has a microcomputer board and a software platform mounted thereon, is connected to a robot system via one serial port. In this case, a robot developer needs to embody a multi-communication function which directly connects devices on the microcomputer board to a plurality of software components via the serial port in the software components. In addition, the software components created as set forth above need to have a complex interface in order to provide an interface with the devices and exhibit a difficult in their reuse and maintenance.

### SUMMARY OF THE INVENTION

In view of the above, the present invention provides an apparatus and method for sharing a plurality of device resources between a plurality of robot software user components, which allows the user components to share the device resources in a robot software platform so that a robot application developer can further effectively configure a robot system.

In accordance with an exemplary embodiment of the present invention, there is provided an apparatus for sharing device resources between robot software user components, which includes: a callback module of a robot software user component configured to receive data forwarded from a device set to be shared between the robot software user components; a device service surrogate configured to have a connection with a framework to forward data to the device or forward data received through the callback module to a user program of the user components; a device service surrogate manager configured to manage the device service surrogate of each of the user components; a device channel configured to have a connection with the device to receive data therefrom and transmit data thereto; and a device channel manager configured to manage the device channel and connect the device channel and the device service surrogate.

In the embodiment, the device service surrogate is registered in the device service surrogate manager, and at the time of the registration of the device service surrogate, the device service surrogate is configured to receive setting information for a device sharing from the device service surrogate manager so that the data reception and transmission between the user components and the device can be supported.

In the embodiment, the device service surrogate is configured to search for a device channel connected to the device to be shared using a channel searching function served by the device service surrogate manager and wherein the device service surrogate is registered as a data receiver in the searched channel in order to receive data from the device.

In the embodiment, the device service surrogate manager, when receiving a data transmission request to a device to be shared from the device service surrogate, is configured to search for a device channel connected to the device and transmit the data forwarded from the device service surrogate to the searched device channel.

In the embodiment, the device channel, when receiving data to be transmitted to the device from the device service surrogate manager, is configured to store the data in an output data queue of the device channel and allows the data to forward to the device at the time of the completion of the write data in progress previously.

In the embodiment, the device channel, when receiving data from the device, is configured to call a callback common interface of the device service surrogate by which the device had been registered as the device to be shared and transmit data via the callback common interface.

In the embodiment, the device channel is assigned to the device one by one.

In the embodiment, the device channel has a unique ID or key that can be identified by the user component for the registration in the device channel manager.

In the embodiment, the device comprises a constituent to configure a robot or connected to a robot.

In the embodiment, the device comprises a serial port, HID (Human Interface Device), sensor, actuator or wheel.

In accordance with an exemplary embodiment of the present invention, there is provided a method for sharing device resources between robot software user components, which includes: registering, in a device channel manager, a device channel connected to a device to be shared between the robot software user components; registering, in a device service surrogate manager, a device service surrogate embedded in each user component; allowing, in the user component, to connect the device channel connected to the device set to be shared with the device service surrogate; and performing transmission and reception of data between the device service surrogate and the device.

In the embodiment, the performing transmission and reception of data includes: at the time of the transmission of data from the user component, transmitting the data through the device service surrogate and the device channel to the device; and at the time of the reception of data from the device, forwarding the data to the device service surrogate which has been registered as a data receiver in the device channel.

In the embodiment, the registering a device service surrogate includes: forwarding, in the device service surrogate manager, setting information for a device sharing to the device service surrogate at the time of the registration of the device service surrogate.

In the embodiment, the transmitting the data includes: receiving, in the device service surrogate manager, a data transmission request to the device from the device service surrogate at the time of the transmission of data from the user component; searching, the device service surrogate manager, a device channel connected to the device and transmitting the data having the data transmission request to the searched device channel; and transmitting, in the device channel, the data to the device.

In the embodiment, the forwarding the data to the device service surrogate includes: calling, in the device channel, when receiving data from the device, a callback common interface of the device service surrogate by which the device had been registered as the device to be shared; and transmitting the data via the callback common interface.

In the embodiment, the device service surrogate searches for a device channel connected to a device to be shared using a channel searching function served by the device service surrogate manager and wherein the device service surrogate is registered as a data receiver in the searched device channel in order to receive data from the device.

In the embodiment, the device channel is assigned to the device one by one.

In the embodiment, the device channel has a unique ID or key that can be identified by the user component for the registration in the device channel manager.

As described above, because the embodiments of the present invention allow a plurality of user components to share a plurality of device resources in a robot software platform, a robot application developer can further effectively configure a robot system.

### BRIEF DESCRIPTION OF THE DRAWINGS

The above and other objects and features of the present invention will become apparent from the following description of the embodiments given in conjunction with the accompanying drawings, in which:

FIG. 1 is a component diagram of an apparatus for sharing device sources in accordance with an exemplary embodiment of the present invention;

FIG. 2 is a block diagram of a component engine for sharing device sources in accordance with an exemplary embodiment of the present invention; and

FIG. 3 is a flow diagram illustrating a method for sharing device sources in accordance with an exemplary embodiment of the present invention.

### DETAILED DESCRIPTION OF THE EMBODIMENTS

Hereafter, the principles of operation of the present invention will be described in detail with reference to the accompanying drawings. In describing the embodiments of the invention, known function or configuration will not be described fully if the detailed description thereof makes the scope and spirit of the invention ambiguous. The following terms are defined in consideration of functions in the embodiments of the invention and may vary in accordance with the intentions of a user or an operator or according to usual practice. Therefore, the definitions of the terms should be interpreted on the basis of the entire content of the specification.

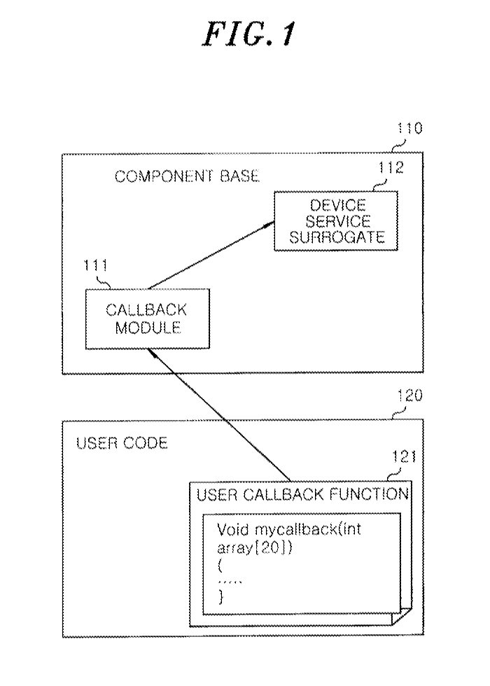

FIG. 1 is a diagram of an apparatus for sharing device sources in accordance with an exemplary embodiment of the present invention.

Referring to FIG. 1, a component base 110 represents a constitution in which primary functionalities of a user component are implemented. The component base 110 includes the callback module 111 and a device service surrogate 112. The callback module 111 is produced by a user in order to register a user callback function 121. The device service surrogate 112 has a connection with a framework and serves to transfer data to devices or data received via the callback module 111 to a user program. A user code 120 functions to create the user callback function 121 which refers to the callback module 111. The user code 120 may be a portion of user codes directly written by a user. The user callback function 121 represents a code of a user callback function, directly written by a user, for the purpose of receiving data from the devices.

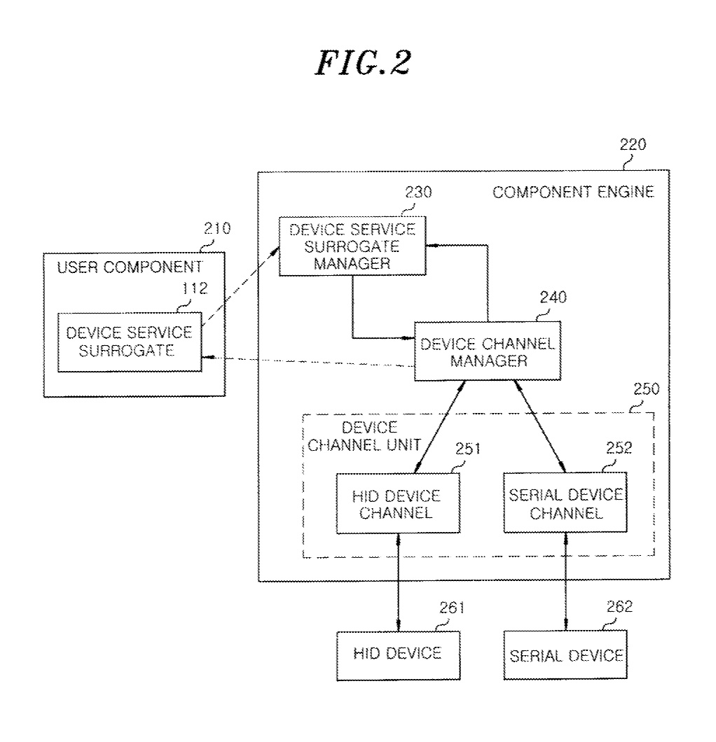

FIG. 2 is a block diagram of a component engine 220 for sharing device sources in accordance with an exemplary embodiment of the present invention.

Referring to FIG. 2, a user component 210 represents one of components written by a user. The user component 210 includes a device service surrogate 112 which has a connection with the framework and serves to transfer data to the devices or data received via the callback module 111 to the user program.

A component engine 220 includes a device service surrogate manager the device service surrogate manager 230, a device channel unit 250, and a device channel manager 240.

The device service surrogate manager 230 manages the device service surrogate 112 in each user component 210.

The device channel unit 250 has a direct connection with devices such as a serial port and HID (Human Interface Device) and receives data from the devices and transmits data to the devices. The device channel unit 250 includes a serial device channel 252 and a HID device channel 251.

The device channel manager 240 manages a plurality of device channels 251 and 252 in the device channel unit 250 and allows the device channels 251 and the serial device channel 252 to connect with the device service surrogate 112.

A reference numeral 261 denotes a HID hardware device which interworks with the HID device channel 251 and a reference numeral 262 denotes a serial hardware device which interworks with the serial device channel 252.

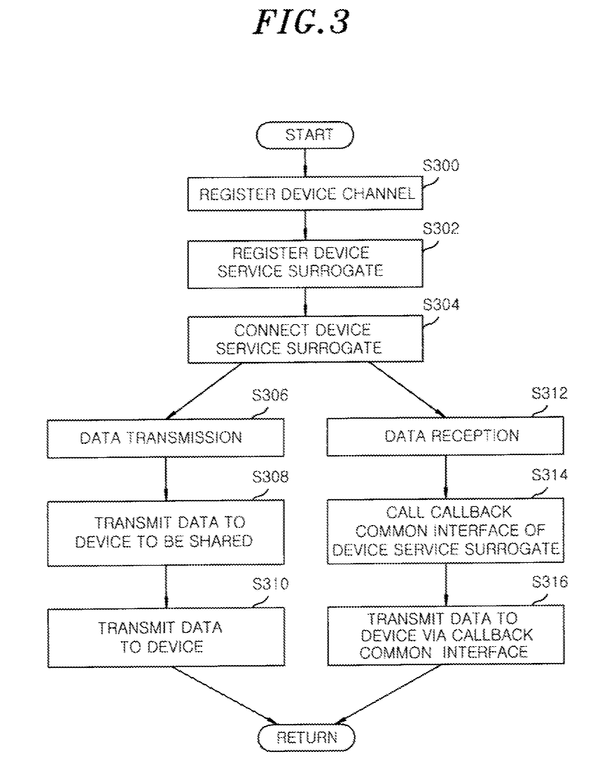

FIG. 3 is a flow diagram illustrating a method for sharing device sources in accordance with an exemplary embodiment of the present invention.

The method of sharing device sources of the embodiment will be explained in detail with reference to FIGS. 1, 2 and 3.

First, the method begins with an operation of a device channel registration, in operation S300, at the time of the execution of the apparatus for device sharing. In operation S300, an instance of the HID device channel 251 and the serial device channel 252 in the device channel unit 250 is created, wherein the instance dedicates a work to read data and write data from each device such as the serial device 262 and the HID device 261 which are to be shared. In this case, the HID device 261 and the serial device 262 have their corresponding device channels assigned thereto such as the HID device channel 251 and the serial device channel 252, respectively.

Further, in a case where there exist several ports such as the serial device 262, the respective ports are regarded as separate ports and are assigned to separate device channels. For example, for a serial port, a device channel for COM1 does not share with a device channel for COM2.

The device channel 251 and 252 produced as set forth above have unique IDs or keys that can be identified by a user, and the unique IDs or keys are registered in the device channel manager 240.

Subsequently, at the initial time of the execution of the user component 210, the registration of the device service surrogate begins with operation S302. In operation 302, the component engine 220, which executes a device share function, requests the device service surrogate 112 from each user component 210 and registers the device service surrogate 112 in the device service surrogate manager 230. When the device service surrogate 112 is registered, the device service surrogate manager 230 sets information for allowing the device share function in the device service surrogate 112. Accordingly, the user code 120 is able to perform such functions to read data from the HID device 261 and the serial device 262 and write data on the HID device 261 and the serial device 262.

Next, at the time of the execution of the user component 210, the connection of the device service surrogate with the device channel begins with operation S304. In operation S304, when the user component 210 desires to have a function of an asynchronous read data from an external device such as the serial device 262 and the serial device 262, the user component 210 writes the user callback function 121, which process data received from each device, in the user code 120 and creates the callback module 111 using a callback module creating function served by the component base 110.

The callback module 111 created as above is registered in the device service surrogate 112 by using a callback registration function served by the component base 110.

Thereafter, when the callback registration function is requested from the user code 120, the device service surrogate 112 uses a channel searching function served by the device service surrogate manager 230 interworking with the device channel manager 240 to search a channel requested by the callback module 111 and is registered as a data receiver in the searched device channel, for example, the HID device channel 251 or the serial device channel 252.

Further, when the user component 210 wants to use a synchronous read data function to synchronously read data from an external device such as the serial device 262 or the HID device the HID device 261, the user component 210 is able to use a synchronous data receiving function served by the device service surrogate 112 via the user code 120.

Subsequently, the device service surrogate 112 creates the callback module 111 using an embedded callback function which had been already prepared in the device service surrogate 112 instead of the user callback function 121 and registers it in an inner callback management portion. Further, the device service surrogate 112 is registered as a data receiver in the device channel which has been searched through the use of the channel searching function served by the device service surrogate manager 230.

As such, when a connection has been made between the device service surrogate 112 and the HID device channel 251 or the serial device channel 252 in the device channel unit 250, a data transmission/reception can be achieved between the device service surrogate 112 and the HID device 261 or the serial device 262.

In this case, first, in operation S306, when the user component 210 wants to use a write data function to write data in an external device such as the serial device 262 or the HID device 261, the user component 210 calls a device data transmission function served by the device service surrogate 112 in the user code 120.

When the device data transmission function is requested from the user code 120, the device service surrogate 112 searches for a device channel, requested by the user component 210, to which the data will be transmitted through the use of the channel searching function served by the device service surrogate manager 230 interworking with the device channel manager 240. Herein, the device channel may be, for example, the HID device channel 251 or the serial device channel 252.

As such, when the device channel to which the data will be transmitted has been searched, the data is transmitted to the HID device channel 251 or the serial device channel 252 through the use of a write data function served by the HID device channel 251 or the serial device channel 252, respectively, in operation S308. In this case, information on the searched device channel may be saved in the device service surrogate 112 so that it can be searched quickly in response to a data transmission request in a future.

Subsequently, when there is a call for the write data function, the device channel 251 or 252 temporarily stores the received data in its output data queue. Thereafter, when the device 261 or 262 has completed the write data in progress, the device channel 251 or 252 then fetches the data in next sequence from the output data queue and performs the write data on the device 261 or 262, in operation S310. In this regard, the sequence of the data stored in the output data queue of the device channel 251 or 252 may be determined in line with a condition such as a priority, deadline, expiration time, or the like, and a weight of the condition may be arbitrary defined by a user.

Following is a description of a case where the user component 210 uses an asynchronous read data function to read asynchronously data from an external device such as the serial device 262 or the HID device the HID device 261.

When data is received from an external device such as the serial device 262 or the HID device 261, in operation S312, a device channel such as the HID device channel 251 or the serial device channel 252 calls a callback common interface served by the device service surrogate 112 which has been registered as a data receiver as in the operation S330 of the connection of the device service surrogate with the device channel, in operation S314. Then, the device service surrogate 112 calls a common data receiving interface of a callback module 111 which had been set as a receiving callback in charge of the external device among a plurality of callback modules. Sequentially, in operation S316, the data from the external device 261 or 262 is transmitted to the callback module 111, and the callback module 111 converts transforms the data delivered via the common data receiving interface in compliance with a parameter type of the user callback function 121 requested by a user and then calls the user callback function 121 to process the data.

On the other hand, following is a description of a case where the user component 210 uses a synchronous read data function to read synchronously data from an external device such as the serial device 262 or the HID device the HID device 261.

In operation S312 where the user component 210 would like to use a function to read data from an external device such as the serial device 262 or the HID device 261, when the user component 210 calls a synchronous data receiving function served by the device service surrogate 112, the synchronous data receiving function is interrupted until the callback common interface of the device service surrogate 112 is called from the device channel 251 or 252.

In this case, when the device channel 251 or 252 which is destined for the reception of data receives data the device 261 or 262, the device channel 251 or 252 calls the callback common interface of the device service surrogate 112 which has been registered as the data receiver, in operation S314, and forwards the data received from the device channel 251 or 252 to an embedded callback through the callback common interface, in operation S316. When the data has been forwarded to the embedded callback, the device service surrogate 112 resumes the interrupted synchronous data receiving function to forward the received data to a user program in a form of a return value and removes the embedded callback which had been registered in the device service surrogate 112.

Thereafter, when there is none of the callback which had been registered in the device service surrogate 112 as a data receiver of the device channel 251 or 252 by removing the embedded callback by the device service surrogate 112, the device service surrogate 112 makes a request for a receipt withdrawal to the device channel 251 or 252 so that the data is no longer received from the device channel 251 or 252.

As described above, in accordance with an exemplary embodiment of the present invention, the embodiment of the present invention allows a plurality of device resources to share with a plurality of user components in a robot software platform and therefore it has a merit that a robot application developer can further effectively configure a robot system.

While the description of the present invention has been made on the exemplary embodiments, various changes and modifications may be made without departing from the scope of the invention. Therefore, the scope of the present invention should be defined by the appended claims rather than by the foregoing embodiments.

What is claimed is:

1. An apparatus for sharing device resources between robot software user components, the apparatus comprising:
a callback module of a robot software user component configured to receive data forwarded from a device set to be shared between the robot software user components;
a device service surrogate configured to have a connection with a framework to forward data to the device or forward data received through the callback module to a user program of the user components;
a device service surrogate manager configured to manage the device service surrogate of each of the user components;
a device channel configured to have a connection with the device to receive data therefrom and transmit data thereto; and
a device channel manager configured to manage the device channel and connect the device channel and the device service surrogate.

2. The apparatus of claim 1, wherein the device service surrogate is registered in the device service surrogate manager, and at the time of the registration of the device service surrogate, the device service surrogate is configured to receive setting information for a device sharing from the device service surrogate manager so that the data reception and transmission between the user components and the device can be supported.

3. The apparatus method of claim 1, wherein the device service surrogate is configured to search for a device channel connected to the device to be shared using a channel searching function served by the device service surrogate manager and wherein the device service surrogate is registered as a data receiver in the searched channel in order to receive data from the device.

4. The apparatus of claim 1, wherein the device service surrogate manager, when receiving a data transmission request to a device to be shared from the device service surrogate, is configured to search for a device channel connected to the device and transmit the data forwarded from the device service surrogate to the searched device channel.

5. The apparatus of claim 4, wherein the device channel, when receiving data to be transmitted to the device from the device service surrogate manager, is configured to store the data in an output data queue of the device channel and allows the data to forward to the device at the time of the completion of the write data in progress previously.

6. The apparatus of claim 3, wherein the device channel, when receiving data from the device, is configured to call a callback common interface of the device service surrogate by which the device had been registered as the device to be shared and transmit data via the callback common interface.

7. The apparatus of claim 1, wherein the device channel is assigned to the device one by one.

8. The apparatus of claim 1, wherein the device channel has a unique ID or key that can be identified by the user component for the registration in the device channel manager.

9. The apparatus of claim 1, wherein the device comprises a constituent to configure a robot or connected to a robot.

10. The apparatus of claim 4, wherein the device comprises a serial port, HID (Human Interface Device), sensor, actuator or wheel.

11. A method for sharing device resources between robot software user components, the method comprising:
registering, in a device channel manager, a device channel connected to a device to be shared between the robot software user components;
registering, in a device service surrogate manager, a device service surrogate embedded in each user component;
allowing, in the user component, to connect the device channel connected to the device set to be shared with the device service surrogate; and
performing transmission and reception of data between the device service surrogate and the device.

12. The method of claim 11, wherein said performing transmission and reception of data comprises:
at the time of the transmission of data from the user component, transmitting the data through the device service surrogate and the device channel to the device; and
at the time of the reception of data from the device, forwarding the data to the device service surrogate which has been registered as a data receiver in the device channel.

13. The method of claim 11, wherein said registering a device service surrogate comprises:
forwarding, in the device service surrogate manager, setting information for a device sharing to the device service surrogate at the time of the registration of the device service surrogate.

14. The method of claim 12, wherein said transmitting the data comprises:
receiving, in the device service surrogate manager, a data transmission request to the device from the device service surrogate at the time of the transmission of data from the user component;
searching, the device service surrogate manager, a device channel connected to the device and transmitting the data having the data transmission request to the searched device channel; and
transmitting, in the device channel, the data to the device.

15. The method of claim 12, wherein said forwarding the data to the device service surrogate comprises:
calling, in the device channel, when receiving data from the device, a callback common interface of the device service surrogate by which the device had been registered as the device to be shared; and
transmitting the data via the callback common interface.

16. The method of claim 11, wherein the device service surrogate searches for a device channel connected to a device to be shared using a channel searching function served by the device service surrogate manager and wherein the device service surrogate is registered as a data receiver in the searched device channel in order to receive data from the device.

17. The method of claim 11, wherein the device channel is assigned to the device one by one.

18. The method of claim 11, wherein the device channel has a unique ID or key that can be identified by the user component for the registration in the device channel manager.
